(19) United States
(12) Patent Application Publication
(10) Pub. No.: US 2026/0343107 A1
(43) Pub. Date: Oct. 29, 2026

(54) METHOD AND APPARATUS FOR REPRODUCING COLOR OF IMAGE

(71) Applicant: PIXELPLUS CO., LTD., Seongnam-si (KR)

(72) Inventor: Han Noh YOON, Seoul (KR)

(21) Appl. No.: 19/713,760

(22) Filed: Jun. 19, 2026

Related U.S. Application Data
(63) Continuation of application No. PCT/KR2024/020739, filed on Dec. 19, 2024.

(30) Foreign Application Priority Data
Dec. 20, 2023 (KR) 10-2023-0187620

(51) Int. Cl. H04N 23/88; H04N 23/85

(52) U.S. Cl. CPC H04N 23/88; H04N 23/85

(57) ABSTRACT

An image color reproduction method provided herein can include the steps of: converting a raw image signal collected through an image sensor into a raw image matrix; correcting a spectral response component of the raw image matrix; and correcting an illumination component of the raw image matrix, wherein the spectral response component is determined according to the image sensor, and the illumination component is determined according to illumination of an environment in which the raw image signal is collected.

### TECHNICAL FIELD

The present disclosure relates to a method and apparatus for image reproduction, and more particularly, to a method and apparatus for reproducing color of an image capable of obtaining a high-quality image without performing a color correction operation on a raw image.

### BACKGROUND ART

A raw image signal collected through an image sensor under illumination having an arbitrary color temperature may be subjected to defect pixel correction, black level compensation, and lens shading compensation to correct pixel-to-pixel variation.

The raw image signal in which pixel-to-pixel variation has been corrected may be represented as a raw image matrix.

The raw image matrix may be a set of matrices generated by converting a raw image signal collected from each of a plurality of pixels included in an image sensor.

The raw image matrix may include, as components, color values for respective channels of the pixels included in the image sensor.

For example, when the image sensor includes pixels having RGB channels, the raw image matrix may be represented in a 3×1 form, and the respective components may indicate an R-channel color value, a G-channel color value, and a B-channel color value.

Each channel-specific color value included in the raw image matrix may be distorted by an image sensor spectral response component, an intrinsic reflectance component of an imaged object, and an illumination component, and thus may have a value different from a color visually perceived by a human under standard illumination (D50 standard illumination, color temperature 5000K).

The spectral response component may be affected by an optical lens, an optical filter, a quantum efficiency (QE) of a photoelectric conversion element, and the like included in the image sensor, and may be a distortion component having characteristics that differ from image sensor to image sensor.

A conventional image color reproduction method may perform white balancing and color correction on a raw image matrix.

White balancing may be an operation of calculating a white balance gain matrix for the raw image matrix to match color channel color values for pixels in an achromatic region.

For example, in an image sensor including RGB channels, white balancing may be an operation of multiplying a raw image matrix for pixels in an achromatic region by a white balance gain matrix to match an R-channel color value, a G-channel color value, and a B-channel color value.

The conventional image color reproduction method has a concern that a raw image matrix for pixels other than pixels in the achromatic region may be distorted by the spectral response component during a white balancing process.

The color correction operation may be an operation of adjusting a weight of each color value by calculating a color correction matrix for the raw image matrix.

The color correction matrix may be experimentally determined according to a type of an image sensor that collects an image signal and a color temperature condition of illumination under which the image signal is collected.

The color correction operation may be an operation of estimating a color temperature of illumination under which image data is collected with reference to a white balance gain, and then applying experimentally-predetermined color correction matrices to the raw image matrix on which white balancing has been completed.

In the color correction operation, based on the raw image matrices to which the color correction matrices are applied, each channel-specific signal value included in the raw image matrix may be corrected to be similar to a color signal value visually perceived by a human under standard illumination.

However, in the conventional image color reproduction method, the white balancing operation is first performed before the color correction operation for the raw image matrix, thereby causing a concern that distortion of the color correction matrix due to the spectral response component may occur.

In addition, the conventional image color reproduction method has a problem in that since the white balance gain matrix is affected by the spectral response component, different white balance gain matrices are applied to image data collected by different image sensors under the same illumination.

Since the white balance gain matrix is used to estimate the color temperature of illumination, it may become difficult to determine the color temperature when the spectral response component affects the white balance gain matrix.

### DETAILED DESCRIPTION OF THE INVENTION

### Technical Problem

An object of the technical idea of the present disclosure is to provide an improved method and apparatus for reproducing color of an image.

An object of the technical idea of the present disclosure is to provide a method and apparatus for reproducing color of an image capable of easily determining a white balance gain matrix and selectively applying color correction by removing a spectral response component from a raw image matrix before white balancing.

Technical problems of the present disclosure are not limited to the technical problems mentioned above, and other technical problems not mentioned will be clearly understood by those skilled in the art from the descriptions below.

### Technical Solutions

An image color reproduction method according to an embodiment of the present disclosure includes the steps of: converting a raw image signal collected through an image sensor into a raw image matrix; correcting a spectral response component of the raw image matrix; and correcting an illumination component of the raw image matrix in which the spectral response component is corrected, wherein the spectral response component corresponds to the image sensor, and the illumination component corresponds to illumination of an environment in which the raw image signal is collected.

According to an embodiment, the step of correcting the spectral response component may include calculating an inverse color response transform matrix and multiplying the raw image matrix by the inverse color response transform matrix.

According to an embodiment, when the image sensor is a 3-channel image sensor, the inverse color response transform matrix may be a 3×3 matrix.

According to an embodiment, when the image sensor is an N-channel image sensor, the inverse color response transform matrix may be a 3×N matrix.

According to an embodiment, the step of calculating the inverse color response transform matrix may include the steps of: collecting a first raw image signal by capturing an image of a preset subject under preset reference illumination; converting the first raw image signal into a first raw image matrix; and algebraically calculating the inverse color response transform matrix based on a reference image matrix for the preset subject under the preset reference illumination and the first raw image matrix, wherein the reference image matrix is a matrix including an ideal image signal value for the preset subject.

According to an embodiment, the step of calculating the inverse color response transform matrix may include the steps of: collecting a first raw image signal by capturing an image of a preset subject under preset reference illumination; converting the first raw image signal into a first raw image matrix; multiplying the first raw image matrix by the inverse color response transform matrix; calculating a first loss function based on a difference between the first raw image matrix multiplied by the inverse color response transform matrix and a reference image matrix in a color space; and recursively calculating the inverse color response transform matrix by reflecting the first loss function, wherein the reference image matrix is a matrix including an ideal image signal value for the preset subject.

According to an embodiment, the color space may be any one of an RGB space, a YUV space, an XYZ space, and a Lab space.

According to an embodiment, the step of calculating the inverse color response transform matrix may include the steps of: collecting a first raw image signal by capturing an image of a preset subject under preset reference illumination; converting the first raw image signal into a first raw image matrix; collecting a second raw image signal by capturing an image of the preset subject under arbitrary illumination; converting the second raw image signal into a second raw image matrix; multiplying the first raw image matrix by the inverse color response transform matrix; calculating a first loss function based on a difference between the first raw image matrix multiplied by the inverse color response transform matrix and a reference image matrix in a color space; multiplying the second raw image matrix by the inverse color response transform matrix; white balancing the second raw image matrix multiplied by the inverse color response transform matrix; calculating a second loss function in the color space based on a difference between the second raw image matrix subjected to the white balancing and the reference image matrix; and recursively calculating the inverse color response transform matrix by reflecting the first loss function and the second loss function, wherein the reference image matrix is a matrix including an ideal image signal value for the preset subject.

According to an embodiment, the color space may be any one of an RGB space, a YUV space, an XYZ space, and a Lab space.

An image color reproduction apparatus according to another embodiment of the present disclosure includes: an image matrix generator configured to convert a raw image signal collected by an image sensor into a raw image matrix; an inverse color response transform unit configured to correct a spectral response component of the raw image matrix; and a white balancing unit configured to correct an illumination component of the raw image matrix in which the spectral response component is corrected, wherein the spectral response component is determined according to the image sensor, and the illumination component is determined according to illumination of an environment in which the raw image matrix is collected.

According to another embodiment, the inverse color response transform unit may correct the raw image matrix using an inverse color response transform matrix.

According to another embodiment, the image color reproduction apparatus may further include a color response correction unit configured to obtain the inverse color response transform matrix.

According to another embodiment, the image matrix generator may convert a first raw image signal, collected by the image sensor by capturing an image of a preset subject under preset reference illumination, into a first raw image matrix, and the color response correction unit may algebraically calculate the inverse color response transform matrix based on a reference image matrix for the preset subject and the first raw image matrix under the reference illumination, wherein the reference image matrix is a matrix including an ideal image signal value for the preset subject.

According to another embodiment, the image matrix generator may convert a first raw image signal, collected by the image sensor by capturing an image of a preset subject under preset reference illumination, into a first raw image matrix, and the color response correction unit may multiply the first raw image matrix by the inverse color response transform matrix, calculate a first loss function based on a difference between the first raw image matrix multiplied by the inverse color response transform matrix and a reference image matrix in a color space, and recursively calculate the inverse color response transform matrix by reflecting the first loss function, wherein the reference image matrix is a matrix including an ideal image signal value for the preset subject.

According to another embodiment, the image matrix generator may convert a first raw signal, collected by the image sensor by capturing an image of a preset subject under preset reference illumination, into a first raw image matrix, and convert a second raw image signal, collected by the image sensor by capturing an image of the preset subject under arbitrary illumination, into a second raw image matrix, and the color response correction unit may multiply the first raw image matrix by the inverse color response transform matrix, calculate a first loss function based on a difference between the first raw image matrix multiplied by the inverse color response transform matrix and the reference image matrix in a color space, multiply the second raw image matrix by the inverse color response transform matrix, perform white balancing on the second raw image matrix multiplied by the inverse color response transform matrix, calculate a second loss function based on a difference between the second raw image matrix subjected to the white balancing and the reference image matrix in the color space, and recursively calculate the inverse color response transform matrix by reflecting the first loss function and the second loss function, wherein the reference image matrix is a matrix including an ideal image signal value for the preset subject.

### Advantageous Effects of the Invention

The image color reproduction method and apparatus of the present disclosure may prevent distortion of a white balance gain matrix due to a spectral response by removing an influence of the spectral response from a raw image matrix before white balancing is performed.

The image color reproduction method and apparatus of the present disclosure may achieve natural image color reproduction even when a raw image signal is collected in an extreme low-light situation or a raw image signal having an extremely insufficient achromatic region is collected, by first removing distortion due to the spectral response from the raw image matrix before performing white balancing.

In addition, the image color reproduction method and apparatus of the present disclosure may achieve excellent color reproduction even without color correction.

In addition, various effects directly or indirectly understood from the present document may be provided.

### BRIEF DESCRIPTION OF DRAWINGS

FIG. 1 is a flowchart illustrating an image color reproduction method according to an embodiment of the present disclosure.

FIG. 2 is an operation flowchart of an embodiment of step S200 shown in FIG. 1.

FIG. 3 is an operation flowchart of an embodiment of step S220 shown in FIG. 2.

FIG. 4 is an operation flowchart of another embodiment of step S220 shown in FIG. 2.

FIG. 5 is an operation flowchart of still another embodiment of step S220 shown in FIG. 2.

FIG. 6 illustrates an image color reproduction apparatus according to an embodiment of the present disclosure.

FIG. 7 is a block diagram of a computing system for executing an image color reproduction method according to an embodiment of the present disclosure.

### MODE FOR INVENTION

Hereinafter, various embodiments of the present invention will be described with reference to the accompanying drawings. Advantages and features of the present invention and a method for achieving the advantages and features will become more apparent from the embodiments described in detail below in conjunction with the accompanying drawings. However, this is not intended to limit the present invention to particular embodiments.

It should be understood that the present invention is not limited to the embodiments, and may be implemented in various different forms, and includes various modifications, equivalents, and/or alternatives of the embodiments of the present invention.

In designation of reference numerals to components in respective drawings, it should be noted that, wherever possible, the same reference numerals may be used throughout the drawings to refer to the same or like components.

In describing an embodiment of the present invention, when it is determined that a detailed description of a related known configuration or function may obscure understanding of the embodiments of the present invention, the detailed description thereof will be omitted.

In the specification, the singular form also includes the plural form unless the context clearly indicates otherwise. As used herein, the terms “comprises” and/or “comprising” do not exclude the presence or addition of one or more other components, steps, operations, and/or elements in addition to the stated components, steps, operations, and/or elements.

Embodiments of the present disclosure relate to a correction method for reproducing a raw image similarly to an image captured under white illumination (D50 standard illumination), the gist of which is to remove a spectral response of a raw image matrix generated from a raw image signal before performing white balancing.

Embodiments of the present disclosure convert a raw image signal collected through an image sensor into a raw image matrix, and remove a spectral response component included in the raw image matrix before white balancing, thereby preventing the raw image matrix from being distorted by the spectral response when white balancing is performed.

Embodiments of the present disclosure remove a spectral response using an inverse color response transform matrix, so that color values collected from pixels other than pixels in an achromatic region may not be distorted by white balancing.

In addition, a spectral response component may be easily removed from a raw image signal collected in a low-light environment or a complex lighting environment, where it is difficult to determine a white balance gain, thereby enabling high-quality image reproduction.

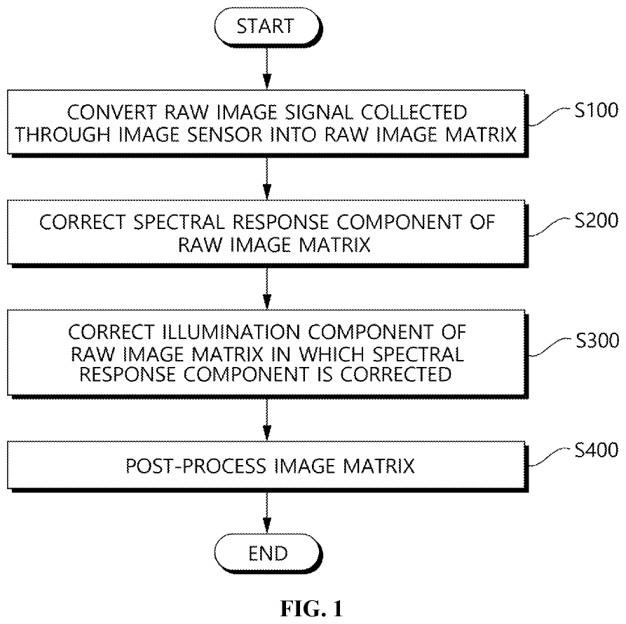

The method and apparatus according to these embodiments of the present disclosure will be described with reference to FIGS. 1 to 7.

FIG. 1 is a flowchart illustrating an image color reproduction method according to an embodiment of the present disclosure.

A method of reproducing an image color by correcting a raw image signal collected through an image sensor will be described in detail with reference to FIG. 1.

Referring to FIG. 1, a raw image signal may be collected through an image sensor, and the collected raw image signal may be converted into a raw image matrix (S100).

The image sensor may include a plurality of pixels. Each of the pixels included in the image sensor may generate an electrical signal corresponding to received incident light.

Each of the pixels may include a plurality of channels, and each pixel may separate signals for respective wavelengths of incident light using the channels.

For example, in the case of a pixel having RGB channels, an R-channel color value, a G-channel color value, and a B-channel color value of incident light may be obtained. Each channel-specific color value may correspond to an intensity of a wavelength included in the incident light.

For example, the R-channel color value may be a component corresponding to an intensity of red light included in incident light, the G-channel color value may indicate a component corresponding to an intensity of green light included in incident light, and the B-channel color value may indicate a component corresponding to an intensity of blue light included in incident light.

The raw image signal collected by the image sensor may be a signal obtained by imaging an arbitrary target under illumination having an arbitrary color temperature.

The raw image signals may be collected in a number corresponding to the number of a plurality of pixels included in the image sensor, and each raw image signal may include channel components matching the number of channels.

According to an embodiment, some noise may be removed from the raw image signal through defect pixel correction, black level compensation, lens shading correction, and the like.

Defect pixel correction may be replacement, based on raw image signals of surrounding pixels, of raw image signals of pixels having abnormal values among pixels included in the image sensor.

Black level compensation may be correction of an image signal of a pixel corresponding to a darkest region based on an accurate black value.

Lens shading correction may be correction for preventing a decrease in intensity (saturation and sensitivity) of raw image signals of pixels located at an edge of a lens due to physical characteristics of the lens included in the image sensor.

After removing noise from the raw image signal, the noise-removed image signal may be converted into a raw image matrix.

The raw image matrix may be obtained by converting a plurality of channel-specific color values included in the noise-removed raw image signal into a matrix.

For example, when the image sensor includes pixels having RGB channels, the raw image matrix may be represented in a 3×1 form, and the respective components may indicate an R-channel color value, a G-channel color value, and a B-channel color value.

According to an embodiment of the present disclosure, after the raw image signal is converted into the raw image matrix, a spectral response component of the raw image matrix may be corrected (S200).

The raw image signal may be distorted by a spectral response component, an intrinsic reflectance component of an imaged object, and an illumination component, and thus may be collected as a value different from a color visually perceived by a human under standard illumination (D50 standard illumination, color temperature 5000K).

The spectral response component is a distortion component caused by the image sensor that collects the raw image signal, and may be affected by an optical lens, an optical filter, a quantum efficiency (QE) of a photoelectric conversion element, and the like included in the image sensor. In other words, the spectral response component is a component corresponding to the image sensor, and may be a component that differs from image sensor to image sensor.

An amount of reflected light may differ according to a color of an object to be imaged. However, a pixel included in the image sensor cannot distinguish a difference in reflectance according to color. The intrinsic reflectance component may be a distortion component generated by a difference in reflectance according to a color of an object to be imaged.

The illumination component may be a distortion caused by illumination under which the image sensor collects an image signal. For example, a color value of an image signal may be distorted according to a color temperature of illumination.

A channel-specific color value Cₖ included in each pixel of the raw image signal collected by the image sensor may be expressed as in Equation 1 below.

Cₖ=∫Qₖ(λ)L(λ)O(λ)dλ [Equation 1]

For example, among the plurality of channels, an R-channel color value may be Cᵣ, a G-channel color value may be C_{g}, and a B-channel color value may be C_{b}. The color value may be obtained by integrating a spectral response component Qₖ(λ), an illumination component L(λ), and a reflectance component O(λ) with respect to a wavelength λ.

When the R-channel color value Cᵣ, the G-channel color value C_{g}, and the B-channel color value C_{b} are expressed as a raw image matrix based on the integral formula, it may be expressed as in Equation 2 below.

$$( \begin{matrix}{C}_{r} \\ {C}_{g} \\ {C}_{b}\end{matrix} ) = ( \begin{matrix}{Q}_{rl} & {Q}_{rm} & {Q}_{rs} \\ {Q}_{gl} & {Q}_{gm} & {Q}_{gs} \\ {Q}_{bl} & {Q}_{bm} & {Q}_{bs}\end{matrix} ) ( \begin{matrix}{L}_{r} & 0 & 0 \\ 0 & {L}_{g} & 0 \\ 0 & 0 & {L}_{b}\end{matrix} ) ( \begin{matrix}{O}_{r} \\ {O}_{g} \\ {O}_{b}\end{matrix} ) \qquad [ Equation 2 ]$$

The raw image matrix C may be expressed as a product of a spectral response matrix Q, an illumination component matrix L, and a reflectance component matrix O.

$$( \begin{matrix}{C}_{r} \\ {C}_{g} \\ {C}_{b}\end{matrix} ) = C , ( \begin{matrix}{Q}_{rl} & {Q}_{rm} & {Q}_{rs} \\ {Q}_{gl} & {Q}_{gm} & {Q}_{gs} \\ {Q}_{bl} & {Q}_{bm} & {Q}_{bs}\end{matrix} ) = Q , ( \begin{matrix}{L}_{r} & 0 & 0 \\ 0 & {L}_{g} & 0 \\ 0 & 0 & {L}_{b}\end{matrix} ) = L , ( \begin{matrix}{O}_{r} \\ {O}_{g} \\ {O}_{b}\end{matrix} ) = O$$

In respective components Q_{kλ} included in the spectral response matrix Q, k may be each channel index (r, g, or b), and λ may indicate a long-wavelength region l, a medium-wavelength region m, and a short-wavelength region s, respectively.

The spectral response matrix Q prepared as an example is for a 3-channel (R channel, G channel, and B channel) image sensor, and thus may be a 3×3 matrix. According to another embodiment, in the case of an image sensor including an additional channel (e.g., an IR channel), the raw image matrix C may be a 4×1 matrix and the spectral response matrix Q may be a 4×3 matrix. In other words, the spectral response matrix Q may be an N×3 matrix (where N is the number of channels).

Alternatively, when the raw image matrix C further includes an offset row, the raw image matrix C may be a matrix having N+1 rows (here, N is the number of channels of the image sensor) and the spectral response matrix Q may be an (N+1)×3 matrix. In addition, in respective component Lk included in the illumination component matrix L, k may be each channel index (r, g, or b), and in respective components Oₖ included in the reflectance component matrix O, k may be each channel index (r, g, or b). The illumination component matrix L may be modeled in the form of a 3×(N+1) matrix according to forms of the raw image matrix C and the spectral response matrix Q.

As can be seen from Equation 2, unlike the illumination component matrix L, the spectral response matrix Q may not be calculated independently for each channel.

A conventional image color reproduction method calculates a white balance gain matrix such that all channel color values included in a raw image matrix C_{gray} corresponding to an achromatic region have the same value, and performs white balancing by multiplying all raw image matrices C by the white balance gain matrix.

The white balance gain matrix according to the conventional image color reproduction method may be distorted in a complex manner by components included in the spectral response matrix Q.

In addition, the conventional image color reproduction method performs color correction after calculating the white balance gain matrix so as to obtain a value corresponding to a color value under standard illumination (D50 illumination).

However, in the case of the conventional image color reproduction method, since color correction is performed after the raw image matrix C is distorted by components included in the spectral response matrix Q, there is a difficulty in that components other than the illumination component (e.g., spectral response matrix components) must be considered.

In addition, there is a disadvantage in that it is difficult to calculate a white balance gain matrix in an extreme low-light situation or a situation in which it is difficult to obtain a raw image corresponding to an achromatic region.

However, the image color reproduction method according to the present disclosure may prevent distortion of the raw image matrix due to the spectral response component by correcting the spectral response component of the raw image matrix before the illumination component.

Correction of the spectral response component may be described mathematically as in Equation 3 below.

Q⁻¹C=LO [Equation 3]

In the above Equation, an inverse matrix Q⁻¹ of the spectral response matrix Q may be referred to as an inverse color response transform matrix.

In the case of a 3-channel image sensor, the inverse color response transform matrix Q⁻¹ of the spectral response matrix Q may be modeled as a 3×3 matrix. In the case of an image sensor including an additional channel (e.g., an IR channel), the inverse color response transform matrix Q⁻¹ may be a 3×4 matrix.

In other words, the inverse color response transform matrix Q⁻¹ may be a 3×N matrix (where N is the number of channels).

In addition, when the raw image matrix C further includes an offset row, the inverse color response transform matrix Q⁻¹ may be a 3×(N+1) matrix. (Provided that here, N is the number of channels of the image sensor).

If the inverse color response transform matrix Q⁻¹ can be obtained, an image matrix LO from which the spectral response component has been removed and in which only the influence of the illumination component remains can be obtained by multiplying the raw image matrix by the inverse color response transform matrix.

In addition, a white balance gain matrix required for the raw image matrix multiplied by the inverse color response transform matrix may be expressed as in Equation 4 below.

$${M}_{w b} {Q}^{- 1} C = {L}_{g} O \qquad [ Equation 4 ]$$

$${M}_{w b} = ( \begin{matrix}{L}_{g} / {L}_{r} & 0 & 0 \\ 0 & 1 & 0 \\ 0 & 0 & {L}_{g} / {L}_{b}\end{matrix} )$$

$${L}_{g} = ( \begin{matrix}{L}_{g} & 0 & 0 \\ 0 & {L}_{g} & 0 \\ 0 & 0 & {L}_{g}\end{matrix} ) = {L}_{w}$$

L_{g} may be represented as L_{w}, which is a scalar value representing an arbitrary standard illumination component, and M_{wb} may be a white balance gain matrix for correcting the illumination component.

Therefore, if the inverse color response transform matrix can be obtained, the raw image matrix can be corrected through a white balance gain matrix including only the illumination component.

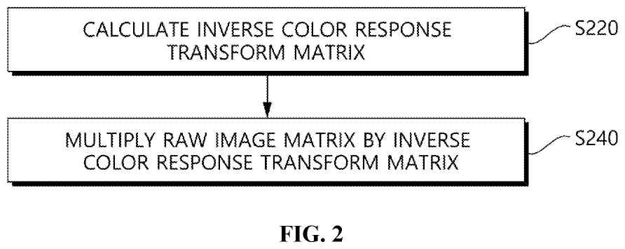

A specific method of correcting the spectral response component will be described in detail with reference to FIGS. 2 to 7.

According to an embodiment of the present disclosure, after the spectral response component of the raw image matrix is corrected, the illumination component of the raw image matrix may be corrected (S300).

Unlike the prior art described above, the image color reproduction method of the present disclosure may correct the illumination component after correcting the spectral response component.

When the spectral response component is corrected from the raw image matrix, distortion due to the spectral response component is eliminated during correction of illumination component, and a separate color correction after correction of illumination component may not be required.

The white balance gain matrix used for correction of illumination component may be the M_{wb} described above.

According to an embodiment of the present disclosure, after correcting the illumination component of the raw image matrix, post-processing of the raw image matrix may be performed (S400).

The post-processing of the raw image matrix may include gamma correction, edge enhancement, color space conversion, and the like.

FIG. 2 is an operation flowchart of an embodiment of step S200 shown in FIG. 1.

A method of correcting a spectral response component of a raw image matrix is shown with reference to FIG. 2.

Referring to FIG. 2, step S200 of correcting the spectral response component of the raw image matrix may include calculating an inverse color response transform matrix (S220).

The inverse color response transform matrix may be calculated by either an algebraic method or a recursive method.

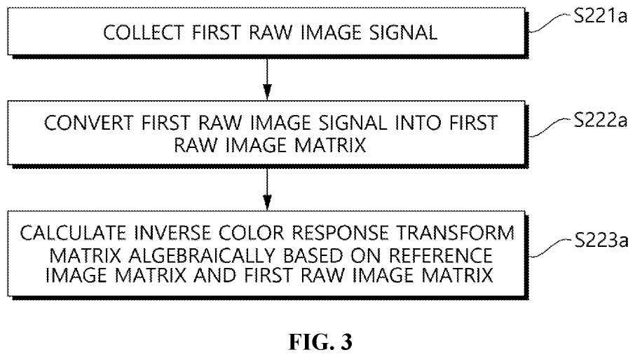

The inverse color response transform matrix may be calculated based on a raw image matrix and a reference image matrix. A method of calculating the inverse color response transform matrix will be described in detail with reference to FIGS. 3 to 7.

When the inverse color response transform matrix is determined by step S220, the raw image matrix may be multiplied by the calculated inverse color response transform matrix (S230). The spectral response component may be removed by multiplying the raw image matrix by the inverse color response transform matrix.

FIG. 3 is an operation flowchart of an embodiment of step S220 shown in FIG. 2.

A method of algebraically calculating the inverse color response transform matrix may be described with reference to FIG. 3.

Referring to FIG. 3, step S220 of calculating the inverse color response transform matrix may include collecting a first raw image signal (S221a).

The first raw image signal may be a raw image signal obtained by capturing an image of a preset subject under preset reference illumination.

For example, the reference illumination may be D50 standard illumination having a color temperature of 5000K. In addition, the preset subject may be a color checker whose color values are known.

Since an ideal image signal value for reference illumination is known for the color checker, a reference image matrix based on the ideal image signal value may be used to calculate the inverse color response transform matrix.

After collecting the first raw image signal, the first raw image signal may be converted into a first raw image matrix (S222a).

A method of converting an image signal into an image matrix may be the same as that described above with reference to FIG. 1.

The inverse color response transform matrix may be algebraically calculated based on the reference image matrix and the first raw image matrix (S223a).

The inverse color response transform matrix may be algebraically calculated based on the first raw image matrix and the reference image matrix corresponding to the first raw image matrix. An algebraic calculation method will be described with reference to Equation 5 below.

Q⁻¹C₁=LOᵣ [Equation 5]

In Equation 5, a product of the first raw image matrix C₁ and the inverse color response transform matrix Q⁻¹ may be collected as a pair corresponding to a reference image matrix LOᵣ for the preset subject under the preset reference illumination.

The inverse color response transform matrix may be calculated using the first raw image matrix C₁ and its pseudo-inverse matrix C₁⁺, and may be expressed as Equation 6 below.

Q⁻¹C₁C₁⁺=LOᵣC₁⁺

Q⁻¹⁼=LOᵣC₁⁺(C₁C₁⁺)⁻¹ [Equation 6]

The first raw image matrix C₁ may be obtained based on the collected first raw image signal, and the reference image matrix LOᵣ has predetermined values as components. Thus, when a sufficient number of pairs of the first raw image matrix C₁ and the reference image matrix LOᵣ are secured, the inverse color response transform matrix Q⁻¹ may be obtained algebraically.

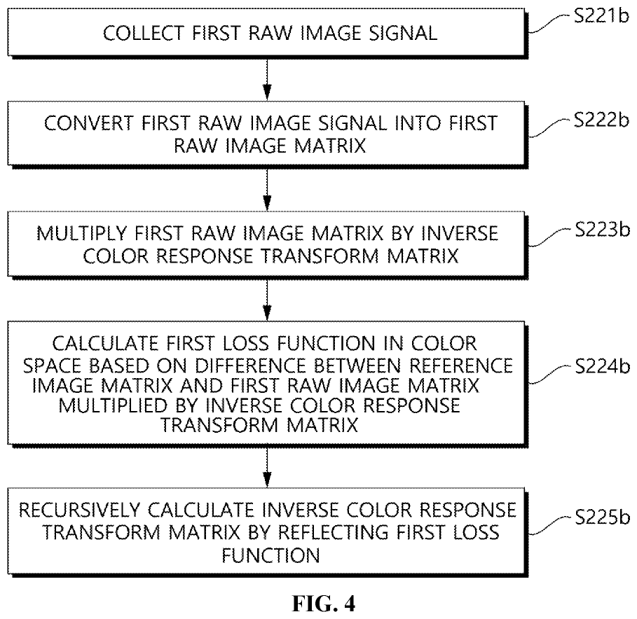

FIG. 4 is an operation flowchart of another embodiment of step S220 shown in FIG. 2.

FIG. 4 illustrates an embodiment of calculating an inverse color response transform matrix when an image signal is collected under reference illumination.

Referring to FIG. 4, step S220 of calculating the inverse color response transform matrix may include collecting a first raw image signal (S221b).

As described above in FIG. 3, the first raw image signal may be a raw image signal obtained by capturing an image of a preset subject under preset reference illumination, and the reference illumination may be D50 standard illumination having a color temperature of 5000K. In addition, the preset subject may be a color checker whose color values are known.

After collecting the first raw image signal, the first raw image signal may be converted into a first raw image matrix (S222b).

Conversion into the raw image matrix may be conversion of a plurality of channel-specific color values included in the first raw image signal into a matrix.

For example, when the image sensor includes a pixel having RGB channels, the first raw image matrix C₁ may be represented in a 3×1 form as below.

$${C}_{1} = ( \begin{matrix}{r}_{1} \\ {g}_{1} \\ {b}_{1}\end{matrix} )$$

Respective components r₁, g₁, and b₁ included in the first raw image matrix C₁ may be channel-specific signal values calculated from the first raw image signal.

Thereafter, the first raw image signal matrix may be multiplied by an inverse color response transform matrix to be obtained (S223b).

For example, the inverse color response transform matrix Q⁻¹ for a 3-channel image sensor may be represented as a 3×3 matrix including arbitrary components a, b, c, d, e, f, g, h, and i as below.

$${Q}^{- 1} = ( \begin{matrix}a & b & c \\ d & e & f \\ g & h & i\end{matrix} )$$

A matrix obtained by multiplying the inverse color response transform matrix Q⁻¹ by the first raw image matrix C₁ may be referred to as a first color response-corrected matrix I₁.

$${I}_{1} = ( \begin{matrix}{R}_{1} \\ {G}_{1} \\ {B}_{1}\end{matrix} )$$

Respective components R₁, G₁, and B₁ included in the first color response-corrected matrix I₁ may be values obtained by correcting respective components r₁, g₁, and b₁ included in the first raw image matrix C₁ by the inverse color response transform matrix Q⁻¹.

In the color space, a first loss function may be calculated based on a difference between the first raw image matrix C₁ multiplied by the inverse color response transform matrix Q⁻¹ and the reference image matrix (S224b).

When the matrix obtained by multiplying the first raw image matrix C₁ by the inverse color response transform matrix Q⁻¹ is referred to as the first color response-corrected matrix I₁, the first color response-corrected matrix I₁ may be a matrix obtained by correcting the first raw image matrix C₁ by the inverse color response transform matrix Q⁻¹.

The reference image matrix may be a matrix having, as components, ideal channel-specific color values obtained when there is no distortion due to a spectral response component when capturing an image of a preset subject under the preset reference illumination.

Each component of the reference image matrix may have an ideal color value for the color checker, which is the preset subject, and the ideal color value may be a value provided by a vendor of the color checker.

The reference image matrix T may be represented as a 3×1 matrix as below.

$$T = ( \begin{matrix}{R}_{i} \\ {G}_{i} \\ {B}_{i}\end{matrix} )$$

As described above, respective components Rᵢ, Gᵢ, and Bᵢ included in the reference image matrix T may be ideal color values provided by the vendor of the color checker.

The color space is a space representing a color representation system in three dimensions, and may include an RGB space, a YUV space, an XYZ space, a Lab space, and the like.

The first color response-corrected matrix I₁ and the reference image matrix T may be represented as arbitrary vectors in the color space.

According to an embodiment, the first loss function E₁ may be calculated based on a difference, in the color space, between the first color response-corrected matrix I₁ and the corresponding reference image matrix T.

In this case, the difference, in the color space, between the first color response-corrected matrix I₁ and the reference image matrix T may be obtained using an angular error, a cosine error, a mean squared error (MSE), a mean absolute error (MAE), or the like.

An exemplary method of calculating the first loss function may be as shown in Equation 7 below.

$$Δ {e}_{1} = {cos}^{- 1} ( \frac{{I}_{1} T}{\vert {I}_{1} \vert \vert T \vert} )$$

$${E}_{1} = \sum Δ {e}_{1}$$

The method of calculating the first loss function E₁ of Equation 7 may be based on a cosine error. A difference Δeᵢ between the first raw image matrix multiplied by the inverse color response transform matrix Q⁻¹ and the reference image matrix may be calculated, and the first loss function E₁ may be calculated based on the sum of the differences.

The inverse color response transform matrix may be recursively calculated by reflecting the calculated first loss function E₁ (S225b).

Recursively calculating the inverse color response transform matrix may mean correcting the inverse color response transform matrix Q⁻¹, which was applied to the first raw image matrix C₁ to calculate the first loss function E₁, based on the first loss function E₁, and performing steps S223b to S224b again using the corrected inverse color response transform matrix Q⁻¹. More specifically, the inverse color response transform matrix Q⁻¹ may be recursively corrected so as to reduce the first loss function E₁.

A more accurate inverse color response transform matrix can be obtained through recursive calculation.

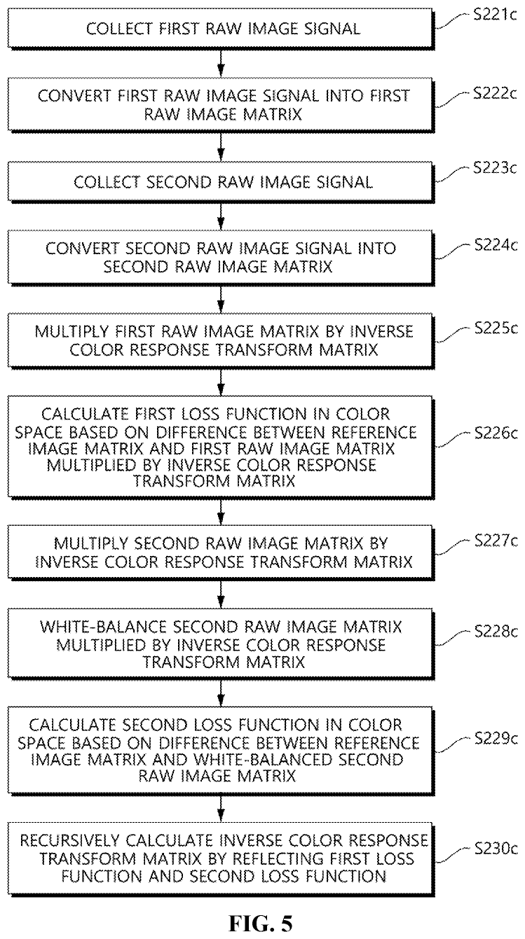

FIG. 5 is an operation flowchart of still another embodiment of step S220 shown in FIG. 2.

FIG. 5 illustrates an embodiment of calculating an inverse color response transform matrix when an image signal is collected under a plurality of illuminations.

Descriptions overlapping with those described above with reference to FIGS. 3 and 4 will be omitted.

Referring to FIG. 5, step S220 of calculating the inverse color response transform matrix may include collecting a first raw image signal (S221c).

As described above in FIG. 3, the first raw image signal may be a raw image signal obtained by capturing an image of a preset subject under preset reference illumination.

In addition, the reference illumination is D50 standard illumination having a color temperature of 5000K, and the preset subject may be a color checker whose color values are known.

After collecting the first raw image signal, the first raw image signal may be converted into a first raw image matrix (S222c).

Conversion into the raw image matrix may be conversion of a plurality of channel-specific color values included in the first raw image signal into a matrix.

As described with reference to FIG. 4, the first raw image matrix C₁ may be represented in a 3×1 form as below.

$${C}_{1} = ( \begin{matrix}{r}_{1} \\ {g}_{1} \\ {b}_{1}\end{matrix} )$$

Step S220 of calculating the inverse color response transform matrix may include collecting a second raw image signal (S223c).

The second raw image signal may be a raw image signal obtained by capturing an image of a preset subject under arbitrary illumination.

The preset subject may be a color checker whose color values are known, as described above.

After collecting the second raw image signal, the second raw image signal may be converted into a second raw image matrix (S224c).

Thereafter, the first raw image signal matrix may be multiplied by an inverse color response transform matrix to be obtained (S225b).

The inverse color response transform matrix Q⁻¹ may be represented as a 3×3 matrix including arbitrary components a, b, c, d, e, f, g, h, and i as below.

$${Q}^{- 1} = ( \begin{matrix}a & b & c \\ d & e & f \\ g & h & i\end{matrix} )$$

A matrix obtained by multiplying the inverse color response transform matrix Q⁻¹ by the first raw image matrix C₁ may be referred to as a first color response-corrected matrix I₁.

$${I}_{1} = ( \begin{matrix}{R}_{1} \\ {G}_{1} \\ {B}_{1}\end{matrix} )$$

Respective components R₁, G₁, and Bᵢ included in the first color response-corrected matrix I₁ may be values obtained by correcting respective components r₁, g₁, and b₁ included in the first raw image matrix C₁ by the inverse color response transform matrix Q⁻¹.

In the color space, a first loss function may be calculated based on a difference between the first raw image matrix C₁ multiplied by the inverse color response transform matrix Q⁻¹ and the reference image matrix (S226c).

The method of calculating the first loss function may be substantially the same as that described with reference to FIG. 4.

Thereafter, the second raw image signal matrix may be multiplied by an inverse color response transform matrix to be obtained (S227c).

$${Q}^{- 1} = ( \begin{matrix}a & b & c \\ d & e & f \\ g & h & i\end{matrix} )$$

The inverse color response transform matrix Q⁻¹ may be as described above, and the second raw image matrix C₂ may be as below.

$${C}_{2} = ( \begin{matrix}{r}_{2} \\ {g}_{2} \\ {b}_{2}\end{matrix} )$$

In addition, a matrix obtained by multiplying the inverse color response transform matrix Q⁻¹ by the second raw image matrix C₂ may be referred to as a second color response-corrected matrix I₂.

$${I}_{2} = ( \begin{matrix}{R}_{2} \\ {G}_{2} \\ {B}_{2}\end{matrix} )$$

The second color response-corrected matrix I₂ may be a matrix obtained by correcting the second raw image matrix C₂ by the inverse color response transform matrix Q⁻¹.

Since the second color response-corrected matrix I₂ is a matrix calculated based on the second raw image matrix C₂ collected under arbitrary illumination, distortion due to an illumination component may occur.

Therefore, it may be necessary to correct distortion due to the illumination component.

White balancing may be performed on the second raw image signal matrix multiplied by the inverse color response transform matrix (S228c).

White balancing may be performed by multiplying by the white balance gain matrix described above. Since the second color response-corrected matrix I₂ is corrected with the inverse color response transform matrix Q⁻¹ in step S227c, only the illumination component may be removed by the white balance gain matrix.

Thereafter, a second loss function may be calculated based on a difference, in the color space, between the white-balanced second raw image matrix and the reference image matrix (S229c).

The reference image matrix may be a matrix having, as components, ideal channel-specific color values obtained when there is no distortion due to a spectral response component when capturing an image of a preset subject under the preset reference illumination.

Each component of the reference image matrix may have an ideal color value for the color checker, which is the preset subject, and the ideal color value may be a value provided by a vendor of the color checker.

The color space is a space representing a color representation system in three dimensions, and may include an RGB space, a YUV space, an XYZ space, a Lab space, and the like.

The white-balanced second color response-corrected matrix I₂ and the reference image matrix T may be represented as arbitrary vectors in the color space.

According to an embodiment, a second loss function E₂ may be calculated based on a difference between the white-balanced second color response-corrected matrix I₂ and the corresponding reference image matrix T in the color space.

As described above, the difference, in the color space, between the second color response-corrected matrix I₂ and the reference image matrix T may be obtained using an angular error, a cosine error, a mean squared error (MSE), a mean absolute error (MAE), or the like.

A method of calculating the second loss function for the white-balanced second color response-corrected matrix I₂ may be as in <Equation 8> below.

$$Δ {e}_{2} = {cos}^{- 1} ( \frac{{I}_{2} T}{\vert {I}_{2} \vert \vert T \vert} ) \qquad [ Equation 8 ]$$

$${E}_{2} = \sum Δ {e}_{2}$$

The method of calculating the second loss function E₂ of Equation 8 may be based on a cosine error. A difference Δe₂ between the second raw image matrix multiplied by the inverse color response transform matrix Q⁻¹ and subjected to white balancing and the reference image matrix may be calculated, and the second loss function E₂ may be calculated based on the sum of the differences.

The inverse color response transform matrix may be recursively calculated by reflecting the calculated first loss function E₁ and second loss function E₂ (S230c).

Recursively calculating the inverse color response transform matrix may mean correcting the inverse color response transform matrix Q⁻¹, which was applied to the first raw image matrix C₁ and the second raw image matrix C₂ to calculate the first loss function E₁ and the second loss function E₂, based on the first loss function E₁ and the second loss function E₂, and performing steps S225c to S229c again using the corrected inverse color response transform matrix Q⁻¹. More specifically, the inverse color response transform matrix Q⁻¹ may be recursively corrected so as to reduce the sum of the first loss function E₁ and the second loss function E₂.

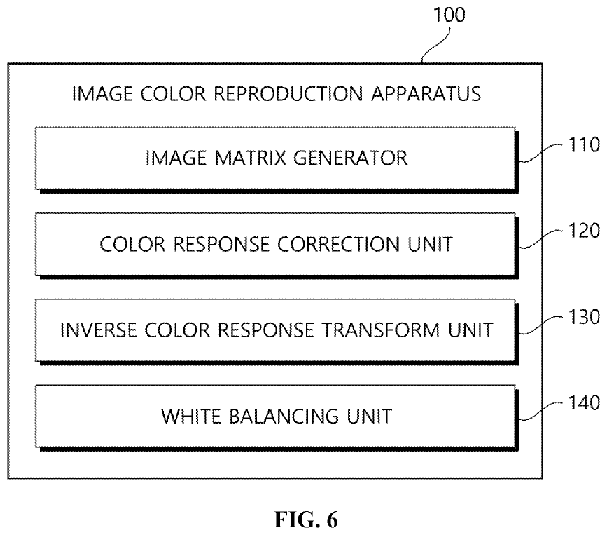

FIG. 6 illustrates an image color reproduction apparatus according to an embodiment of the present disclosure.

An image color reproduction apparatus 100 according to an embodiment of the present disclosure may include an image matrix generator 110 configured to receive an image signal from an image sensor that collects a raw image signal, and to convert the received raw image signal into a raw image matrix.

The image matrix generator 110 may perform defect pixel correction, black level correction, and lens shading correction on the raw image signal collected by the image sensor.

Noise of the raw image signal may be removed through defect pixel correction, black level correction, and lens shading correction. The image matrix generator 110 may generate a matrix having, as components, a plurality of channel-specific color values included in the raw image signal after removing noise.

For example, when a pixel included in the image sensor includes RGB channels, the image matrix generator 110 may convert the noise-removed raw image signal into a matrix in a 3×1 form. In this case, respective components included in the 3×1 matrix may mean an R-channel color value, a G-channel color value, and a B-channel color value.

The image color reproduction apparatus 100 may include a color response correction unit 120 configured to calculate an inverse color response transform matrix.

The color response correction unit 120 may calculate the inverse color response transform matrix based on a first raw image matrix and a reference image matrix corresponding to the first raw image matrix.

The first raw image matrix may be a matrix generated based on a first raw image signal obtained by capturing an image of a preset subject under a preset reference illumination.

For example, the reference illumination may be D50 standard illumination having a color temperature of 5000K. In addition, the preset subject may be a color checker whose color values are known.

According to an embodiment, the inverse color response transform matrix may be algebraically calculated or recursively calculated based on the first raw image matrix and the reference image matrix.

According to another embodiment, the inverse color response transform matrix may be recursively calculated by further using a second raw image matrix as well as the first raw image matrix and the reference image matrix.

The second raw image matrix may be a matrix generated based on a second raw image signal obtained by capturing an image of a preset subject under arbitrary illumination.

Since the algebraic calculation method and the recursive calculation method of the inverse color response transform matrix have been described above with reference to FIGS. 3 to 5, detailed descriptions thereof will be omitted.

The image color reproduction apparatus 100 may include an inverse color response transform unit 130 configured to correct a spectral response component of the raw image matrix.

The inverse color response transform unit 130 may remove the spectral response component of the raw image matrix using the inverse color response transform matrix.

The image color reproduction apparatus 100 according to an embodiment of the present disclosure includes the inverse color response transform unit 130, thereby pre-removing the spectral response component in advance before white balancing.

As the spectral response component is removed in advance, distortion of the raw image matrix due to the spectral response component may not occur when white balancing is performed.

In addition, by removing a spectral response component having different characteristics that differ for each image sensor, only the illumination component can remain in the raw image matrix, thereby enabling intuitive image color reproduction.

Even when the image sensor is replaced or changed, the image color reproduction apparatus according to an embodiment of the present disclosure may obtain an inverse color response transform matrix corresponding to each image sensor and perform image color reproduction based on the inverse color response transform matrix, and thus image color reproduction may be simplified compared to a conventional image color reproduction method.

In addition, even when the spectral response characteristic of the replaced image sensor is different from the spectral response characteristic of the image sensor before replacement, the image color can be easily reproduced.

The image color reproduction apparatus 100 may include a white balancing unit 140 configured to remove the illumination component after calculating the inverse color response transform matrix.

Unlike a conventional image color reproduction method, the white balancing unit 140 removes the illumination component of the raw image matrix after the spectral response component is removed, and thus white balancing distortion due to the spectral response component may not occur in the raw image matrix.

The image color reproduction apparatus 100 may further include an image post-processing unit configured to post-correct the raw image matrix from which the illumination component has been removed through white balancing. According to an embodiment, the image post-processing unit may perform gamma correction, edge enhancement, color space conversion, and the like.

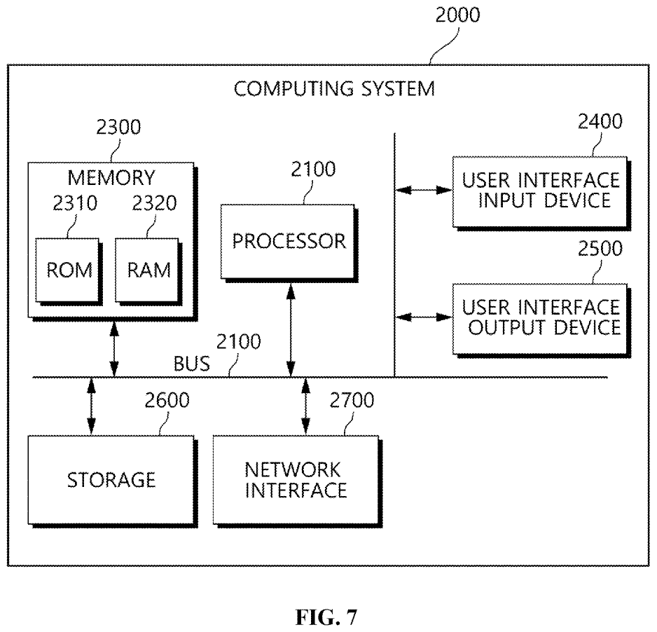

FIG. 7 is a block diagram of a computing system for executing an image color reproduction method according to an embodiment of the present disclosure.

Referring to FIG. 7, the image color reproduction method according to an embodiment of the present disclosure described above may be implemented through a computing system. A computing system 2000 may include at least one processor 2100, a memory 2300, a user interface input device 2400, a user interface output device 2500, a storage 2600, and a network interface 2700 connected through a system bus 2200.

The processor 2100 may be a central processing unit (CPU) or a semiconductor device that executes processing of instructions stored in the memory 2300 and/or the storage 2600. The memory 2300 and the storage 2600 may include various types of volatile or non-volatile storage media. For example, the memory 2300 may include a read only memory (ROM) 2310 and a random access memory (RAM) 2320.

Accordingly, the steps of a method or algorithm described in connection with the embodiments disclosed herein may be directly implemented as hardware executed by the processor 2100, a software module, or a combination of the two. A software module may reside in a storage medium (i.e., the memory 2300 and/or the storage 2600) such as a RAM memory, a flash memory, a ROM memory, an EPROM memory, an EEPROM memory, registers, a hard disk, a removable disk, or a CD-ROM. An exemplary storage medium is coupled to the processor 2100, and the processor 2100 may read information from, and write information to, the storage medium. Alternatively, the storage medium may be integral with the processor 2100. The processor 2100 and the storage medium may reside in an application-specific integrated circuit (ASIC). The ASIC may reside in a user terminal. Alternatively, the processor 2100 and the storage medium may reside as discrete components in the user terminal.

Although embodiments of the present invention have been described above with reference to the accompanying drawings, those of ordinary skill in the art to which the present invention pertains will understand that the present invention can be implemented in other specific forms without changing the technical spirit or essential features thereof. Therefore, it should be understood that the embodiments described above are illustrative in all respects and not restrictive.

1. A method of reproducing color of an image, the method comprising the steps of:
converting a raw image signal collected through an image sensor into a raw image matrix;
correcting a spectral response component of the raw image matrix; and
correcting an illumination component of the raw image matrix in which the spectral response component is corrected,
wherein the spectral response component corresponds to the image sensor, and
the illumination component corresponds to illumination of an environment in which the raw image signal is collected.

2. The method of claim 1, wherein the step of correcting the spectral response component comprises:
calculating an inverse color response transform matrix; and
multiplying the raw image matrix by the inverse color response transform matrix.

3. The method of claim 2, wherein when the image sensor is a 3-channel image sensor, the inverse color response transform matrix is a 3×3 matrix.

4. The method of claim 2, wherein when the image sensor is an N-channel image sensor, the inverse color response transform matrix is a 3×N matrix.

5. The method of claim 2, wherein the step of calculating the inverse color response transform matrix comprises:
collecting a first raw image signal by capturing an image of a preset subject under preset reference illumination;
converting the first raw image signal into a first raw image matrix; and
algebraically calculating the inverse color response transform matrix based on a reference image matrix for the preset subject under the preset reference illumination and the first raw image matrix,
wherein the reference image matrix is a matrix including an ideal image signal value for the preset subject.

6. The method of claim 2, wherein the step of calculating the inverse color response transform matrix comprises:
collecting a first raw image signal by capturing an image of a preset subject under preset reference illumination;
converting the first raw image signal into a first raw image matrix;
multiplying the first raw image matrix by the inverse color response transform matrix;
calculating a first loss function based on a difference between the first raw image matrix multiplied by the inverse color response transform matrix and a reference image matrix in a color space; and
recursively calculating the inverse color response transform matrix by reflecting the first loss function,
wherein the reference image matrix is a matrix including an ideal image signal value for the preset subject.

7. The method of claim 6, wherein the color space is any one of an RGB space, a YUV space, an XYZ space, and a Lab space.

8. The method of claim 2, wherein the step of calculating the inverse color response transform matrix comprises:
collecting a first raw image signal by capturing an image of a preset subject under preset reference illumination;
converting the first raw image signal into a first raw image matrix;
collecting a second raw image signal by capturing an image of the preset subject under arbitrary illumination;
converting the second raw image signal into a second raw image matrix; multiplying the first raw image matrix by the inverse color response transform matrix;
calculating a first loss function based on a difference between the first raw image matrix multiplied by the inverse color response transform matrix and a reference image matrix in the color space;
multiplying the second raw image matrix by the inverse color response transform matrix;
white balancing the second raw image matrix multiplied by the inverse color response transform matrix;
calculating a second loss function based on a difference between the second raw image matrix subjected to white balancing and the reference image matrix in the color space; and
recursively calculating the inverse color response transform matrix by reflecting the first loss function and the second loss function,
wherein the reference image matrix is a matrix including an ideal image signal value for the preset subject.

9. The method of claim 8, wherein the color space is any one of an RGB space, a YUV space, an XYZ space, and a Lab space.

10. An apparatus for reproducing color of an image, the apparatus comprising:
an image matrix generator configured to convert a raw image signal collected by an image sensor into a raw image matrix;
an inverse color response transform unit configured to correct a spectral response component of the raw image matrix; and
a white balancing unit configured to correct an illumination component of the raw image matrix in which the spectral response component is corrected,
wherein the spectral response component is determined according to the image sensor, and
the illumination component is determined according to illumination of an environment in which the raw image matrix is collected.

11. The apparatus of claim 10, wherein the inverse color response transform unit corrects the raw image matrix using an inverse color response transform matrix.

12. The apparatus of claim 11, further comprising a color response correction unit configured to obtain the inverse color response transform matrix.

13. The apparatus of claim 12, wherein the image matrix generator converts a first raw image signal, collected by the image sensor by capturing an image of a preset subject under preset reference illumination, into a first raw image matrix,
the color response correction unit algebraically calculates the inverse color response transform matrix based on a reference image matrix for the preset subject under the reference illumination and the first raw image matrix, and
the reference image matrix is a matrix including an ideal image signal value for the preset subject.

14. The apparatus of claim 12, wherein the image matrix generator converts a first raw image signal, collected by the image sensor by capturing an image of a preset subject under preset reference illumination, into a first raw image matrix,
the color response correction unit multiplies the first raw image matrix by the inverse color response transform matrix, calculates a first loss function based on a difference between the first raw image matrix multiplied by the inverse color response transform matrix and a reference image matrix in a color space, and recursively calculates the inverse color response transform matrix by reflecting the first loss function, and
the reference image matrix is a matrix including an ideal image signal value for the preset subject.

15. The apparatus of claim 14, wherein the image matrix generator converts a first raw signal, collected by the image sensor by capturing an image of a preset subject under preset reference illumination, into a first raw image matrix, and converts a second raw image signal, collected by the image sensor by capturing an image of the preset subject under arbitrary illumination, into a second raw image matrix,
the color response correction unit multiplies the first raw image matrix by the inverse color response transform matrix, calculates a first loss function based on a difference between the first raw image matrix multiplied by the inverse color response transform matrix and the reference image matrix in a color space, multiplies the second raw image matrix by the inverse color response transform matrix, performs white balancing on the second raw image matrix multiplied by the inverse color response transform matrix, calculates a second loss function based on a difference between the second raw image matrix subjected to white balancing and the reference image matrix in the color space, and recursively calculates the inverse color response transform matrix by reflecting the first loss function and the second loss function, and
the reference image matrix is a matrix including an ideal image signal value for the preset subject.
